(19) United States
(12) Patent Application Publication
(10) Pub. No.: US 2026/0260457 A1
(43) Pub. Date: Sep. 3, 2026

(54) POINT CLOUD DESCRIPTOR MATCHING METHOD AND SYSTEM BASED ON COMPLEX VECTOR ANGLE CHARACTERISTICS

(71) Applicant: CHANG'AN UNIVERSITY, Xi'an (CN)

(72) Inventors: Xiangmo ZHAO, Xi'an (CN); Wuqi WANG, Xi'an (CN); Haigen MIN, Xi'an (CN); Xia WU, Xi'an (CN); Zhigang XU, Xi'an (CN); Xuming SHANG, Xi'an (CN); Zhanwen LIU, Xi'an (CN); Runmin WANG, Xi'an (CN); Yanbing YAN, Xi'an (CN); Yukun FANG, Xi'an (CN); Wenjing WANG, Xi'an (CN); Sen XIA, Xi'an (CN); Xiaoping LEI, Xi'an (CN); Yao LI, Xi'an (CN); Changlei YAN, Xi'an (CN); Long YANG, Xi'an (CN)

(21) Appl. No.: 19/657,206

(22) Filed: Apr. 24, 2026

Related U.S. Application Data
(63) Continuation of application No. PCT/CN2024/144336, filed on Dec. 31, 2024.

(30) Foreign Application Priority Data
Oct. 31, 2023 (CN) 202311438446.8

(51) Int. Cl. G06V 10/74; G06V 10/46

(52) U.S. Cl. CPC G06V 10/761; G06V 10/46

(57) ABSTRACT

A point cloud descriptor matching method based on complex vector angle characteristics is provided. Dimensionality reduction is performed on an original complex descriptor to obtain a complex descriptor derivative. Rapid retrieval and filtering are performed by using the complex descriptor derivative in a database to obtain filtered complex descriptors. Similarity comparison is performed on the filtered complex descriptors by utilizing multiple angle characteristics of complex vectors to obtain a complex descriptor with a preset accuracy among the filtered complex descriptors. Possible complex descriptors are rapidly retrieved and filtered out by virtue of the constructed derivative respectively, and the accurate matching of the same position is ultimately completed by utilizing the multiple angle characteristics of complex vectors. A point cloud descriptor matching method based on complex vector angle characteristics is also provided.

### CROSS-REFERENCE TO RELATED APPLICATIONS

This application is a continuation of International Patent Application No. PCT/CN2024/144336, filed on Dec. 31, 2024, which claims the benefit of priority from Chinese Patent Application No. 202311438446.8, filed on Oct. 31, 2023. The content of the aforementioned application, including any intervening amendments made thereto, is incorporated herein by reference in its entirety.

### TECHNICAL FIELD

This application relates to high-precision positioning for autonomous driving, and more particularly to a point cloud descriptor matching method and system based on complex vector angle characteristics.

### BACKGROUND

Autonomous driving and advanced driver assistance play a pivotal role in the current and future transportation sector. By independently perceiving the driving environment and making decisions to control vehicles safely, they not only effectively free human drivers from manual operation, but also enhance traffic efficiency through information interaction and data sharing among vehicles. Position information is a vital component of autonomous driving. Accurate position data provides a safety foundation for the decision-making and control processes of autonomous driving. In complex urban environments, due to the presence of the multipath effect, position information obtained solely via the Global Navigation Satellite System (GNSS) may suffer from significant deviations, which can lead to vehicle positioning failures. At present, positioning solutions relying on high-precision maps have been widely adopted. By matching data collected by on-board sensors with pre-loaded maps, accurate vehicle position information can be obtained. However, the process of constructing high-precision maps is rather complex, and matching real-time data with map information also consumes excessive computing resources.

In order to address the high time cost of map construction, existing solutions leverage the concept of crowdsourcing, dividing the target map into multiple sub-regions and utilizing multiple mapping devices to complete the map construction. Map stitching and place recognition are indispensable for merging individual sub-regions. To improve detection efficiency, existing place recognition methods map the key information from each measurement to a compact descriptor. In addition, to enhance environmental representation capability, some methods utilize complex numbers to store more measurement results, thereby forming complex-valued descriptors. Place recognition for the same location is achieved through descriptor matching. Most existing methods directly adopt brute-force matching to evaluate descriptor similarity, which not only fails to meet the required recall rate, but also consumes substantial computing resources. When faced with large-scale map construction or vehicle positioning in extensive scenarios, traditional place recognition methods may lead to a series of problems such as detection failure or false detection. These issues render the methods unable to satisfy the requirements of map construction and vehicle positioning, ultimately hindering the normal operation of autonomous driving or advanced driver assistance.

### SUMMARY

An object of the disclosure is to provide a point cloud descriptor matching method and system based on complex vector angle characteristics, so as to overcome the problems of low efficiency, low information content of used point cloud data, detection failure and false detection in map construction via descriptor acquisition in the prior art.

In order to achieve the above object, the following technical solutions are adopted.

In a first aspect, this application provides a point cloud descriptor matching method based on complex vector angle characteristics, comprising:
(S1) performing dimensionality reduction on an original complex descriptor structure to obtain a complex descriptor derivative;
(S2) performing, by using the complex descriptor derivative, rapid retrieval and rapid filtering in a database to obtain filtered complex descriptors; and
(S3) performing, by utilizing multiple angle characteristics of complex vectors, similarity comparison on the filtered complex descriptors to obtain a complex descriptor with a preset accuracy among the filtered complex descriptors.

In some embodiments, the dimensionality reduction is performed in a column-wise dimension and a spatial-wise dimension, respectively.

In some embodiments, the dimensionality reduction is performed in the column-wise dimension to obtain a derivative having rotation invariance.

In some embodiments, the original complex descriptor is expressed as Cᵢⱼ=Rᵢⱼ+Iᵢⱼ(i≤Nr, j≤Ns), which is a two-dimensional (2D) complex matrix having Nr rows and Ns columns and corresponds to a plurality of curvilinear trapezoids formed by radial and circumferential segmentation of a lidar, a real part Rᵢⱼ and an imaginary part Iᵢⱼ of the original complex descriptor are configured to store two main features of the plurality of curvilinear trapezoids respectively; and
step (S1) comprises:

calculating a modulus value for each complex element of the original complex descriptor, expressed as:

$${M}_{ij} = mod ( {C}_{ij} ) = \sqrt{{R}_{ij}^{2} + {I}_{ij}^{2}} ( i \leq N r , j \leq Ns ) , \qquad ( 1 )$$

wherein in equation (1), Mᵢⱼ is a real matrix identical in structure and size to the original complex descriptor, and is defined as a modulus matrix storing a modulus value of the original complex descriptor;
degenerating the original complex descriptor into an Nr-dimensional column vector K=[k₁, k₂, . . . , k_{Nr}] to further compress original feature information, wherein kᵢ is expressed as:

$${k}_{i} = {\sum }_{j = 1}^{{N}_{s}} {M}_{ij} ; \qquad ( 2 )$$

and
calculating an average value of each row vector of the modulus matrix, and reflecting original row information through the average value, so that the original complex descriptor is compressed into a one-dimensional vector.

In some embodiments, the dimensionality reduction is performed in the spatial-wise dimension to obtain a derivative having feature distribution characteristics.

In some embodiments, the derivative having the feature distribution characteristics is obtained through steps of:
calculating a logical derivative through equation (3) to reflect feature distribution of the original complex descriptor:

$${B}_{ij} = \{ \begin{matrix}1 & \vert {C}_{ij} \vert \neq 0 \\ 0 & \vert {C}_{ij} \vert = 0\end{matrix} ( i \leq {N}_{s} , j \leq {N}_{r} ) , \qquad ( 3 )$$

wherein the logical derivative is a logical matrix identical in structure and size to the original complex descriptor, and is configured for recording the feature distribution of the original descriptor by calculating a feature modulus of each element of the original complex descriptor.

In some embodiments, the rapid retrieval is performed by using a derivative having rotation invariance to obtain complex descriptors meeting a preset threshold, and the rapid filtering is performed by using a derivative having identical feature distribution to remove results having low feature similarity from the complex descriptors meeting the preset threshold, thereby retaining an optimal complex descriptor.

In a second aspect, this application provides a point cloud descriptor matching system based on complex vector angle characteristics, comprising:
a derivative construction module;
a retrieval and filtering module; and
a matching module;
wherein the derivative construction module is configured to perform dimensionality reduction on an original complex descriptor to obtain a complex descriptor derivative;
the retrieval and filtering module is configured to perform, by using the complex descriptor derivative, rapid retrieval and rapid filtering in a database to obtain filtered complex descriptors; and
the matching module is configured to perform, by utilizing multiple angle characteristics of complex vectors, similarity comparison on the filtered complex descriptors to obtain a complex descriptor with a preset accuracy among the filtered complex descriptors.

In some embodiments, the dimensionality reduction is performed in a column-wise dimension and a spatial-wise dimension, respectively; and the dimensionality reduction is performed in the column-wise dimension to obtain a derivative having rotation invariance.

In some embodiments, the original complex descriptor is expressed as Cᵢⱼ=Rᵢⱼ+Iᵢⱼ(i≤Nr, j≤Ns), which is a 2D complex matrix having Nr rows and Ns columns and corresponds to a plurality of curvilinear trapezoids formed by radial and circumferential segmentation of a lidar, a real part Rᵢⱼ and an imaginary part Iᵢⱼ of the original complex descriptor are configured to store two main features of the plurality of curvilinear trapezoids respectively; and
the derivative construction module is configured to perform steps of:
calculating a modulus value for each complex element of the original complex descriptor, expressed as:

$${M}_{ij} = mod ( {C}_{ij} ) = \sqrt{{R}_{ij}^{2} + {I}_{ij}^{2}} ( i \leq N r , j \leq Ns ) , \qquad ( 1 )$$

wherein in equation (1), Mᵢⱼ is a real matrix identical in structure and size to the original complex descriptor, and is defined as a modulus matrix storing a modulus value of the original complex descriptor;
degenerating the original complex descriptor into an Nr-dimensional column vector K=[k₁, k₂, . . . , k_{Nr}] to further compress original feature information, wherein kᵢ is expressed as:

$${k}_{i} = {\sum }_{j = 1}^{{N}_{s}} {M}_{ij} ; \qquad ( 2 )$$

and
calculating an average value of each row vector of the modulus matrix, and reflecting original row information through the average value, so that the original complex descriptor is compressed into a one-dimensional vector.

Compared to the prior art, the present disclosure has the following beneficial effects.

The present disclosure provides a point cloud descriptor matching method based on complex vector angle characteristics. Dimensionality reduction is performed on an original complex descriptor to obtain the complex descriptor derivative. Rapid retrieval and rapid filtering are performed by using the complex descriptor derivative in a database to obtain filtered complex descriptors. Similarity comparison is performed on the filtered complex descriptors by utilizing multiple angle characteristics of complex vectors to obtain a complex descriptor with a preset accuracy among the filtered complex descriptors. Possible complex descriptors are rapidly retrieved and filtered out by virtue of the constructed derivative respectively, and the accurate matching of the same position is ultimately completed by utilizing the multiple angle characteristics of complex vectors. The present disclosure takes into account the characteristics of the original complex descriptor, acquires derivatives corresponding to different features, and thus improves the utilization efficiency of the original complex descriptor.

This application aims to address the problem of location recognition when a vehicle repeatedly passes through the same environment. Specifically, the lidar is installed on the vehicle. When the vehicle passes through a certain environment for the first time, the lidar scans the environment in a time sequence as the vehicle moves, and the scan data is stored in a database. When the vehicle passes through the same environment for the second time, the current lidar scan results are compared with the scan data in the database to determine whether it is the same location. If it is the same location, it can be applied to positioning. This enables loop closure detection during map construction and global localization during vehicle operation.

Preferably, in view of the low efficiency of traditional brute-force search, the present disclosure achieves rapid retrieval and filtration of potential candidates from candidate data in a hierarchical manner by virtue of the derivatives of the descriptor.

Preferably, the present disclosure results in improved information utilization rate of the descriptor and enhanced accuracy of place recognition by virtue of the different characteristics of various angles of complex vectors.

### BRIEF DESCRIPTION OF THE DRAWINGS

FIG. 1 is a flow chart of a point cloud descriptor matching method based on complex vector angle characteristics in accordance with an embodiment of the present disclosure;

FIG. 2 is a schematic diagram of a derivative having rotation invariance in accordance with an embodiment of the present disclosure; and

FIG. 3 is a schematic diagram of a derivative having feature distribution characteristics in accordance with an embodiment of the present disclosure.

### DETAILED DESCRIPTION OF EMBODIMENTS

In order to enable those of ordinary skill in the art to better understand the solutions of the present disclosure, the technical solutions in the embodiments of the present disclosure will be clearly and completely described below in conjunction with the accompanying drawings of the present disclosure. Obviously, described herein are merely some embodiments of the present disclosure, rather than all embodiments. Based on the embodiments of the present disclosure, all other embodiments obtained by those of ordinary skill in the art without making creative efforts shall fall within the scope of the present disclosure.

It should be noted that terms “first”, “second”, etc. in the specification, claims and drawings of this application are adopted to distinguish similar objects, and are not necessarily adopted to describe a specific order or sequence. It should be understood that these terms can be interchanged where appropriate, so that the embodiments of the present disclosure described herein can, be implemented in an order other than those illustrated or described herein. In addition, terms “comprise”, “include”, or any other variations thereof are intended to cover a non-exclusive inclusion. For example, a process, method, system, product or device that includes a list of steps or units is not necessarily limited to those steps or units explicitly listed, but may include other steps or units that are not explicitly listed or are inherent to such process, method, product or device.

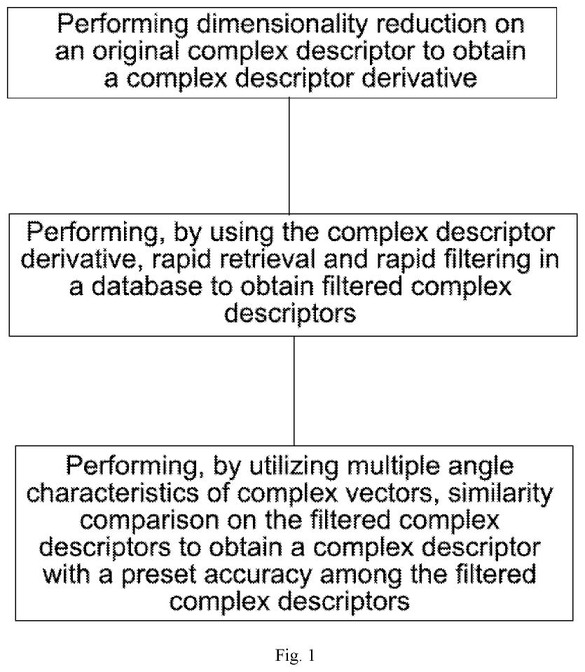

As shown in FIG. 1, the present disclosure provides a point cloud descriptor matching method based on complex vector angle characteristics. Different features of original descriptors are obtained by constructing a derivative of the complex descriptor. Potential candidates are rapidly retrieved and filtered by means of the constructed derivative. Finally, precise matching of the same position is completed by utilizing the characteristics of various angles of complex vectors. The present disclosure not only improves the efficiency of place recognition but also enhances the place recognition accuracy, including the following steps.

Step (S1) Dimensionality reduction is performed on an original complex descriptor to obtain a complex descriptor derivative.

Step (S2) Rapid retrieval and filtering are performed by using the complex descriptor derivative in a database to obtain filtered complex descriptors.

Step (S3) Similarity comparison is performed on the filtered complex descriptors by utilizing multiple angle characteristics of complex vectors to obtain a complex descriptor with a preset accuracy among the filtered complex descriptors.

The point cloud descriptor matching method specifically includes the following steps.

The dimensionality reduction is performed in column-wise and spatial-wise dimensions, respectively.

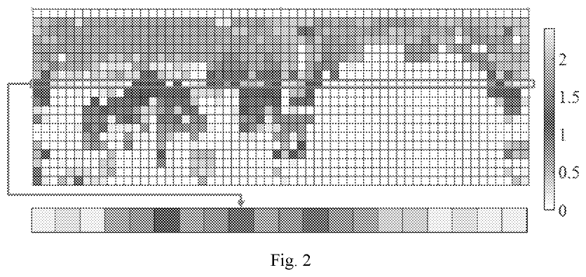

Step (1-1) The dimensionality reduction is performed in the column-wise dimension to obtain a derivative with rotation invariance for rapid retrieval, as shown in FIG. 2.

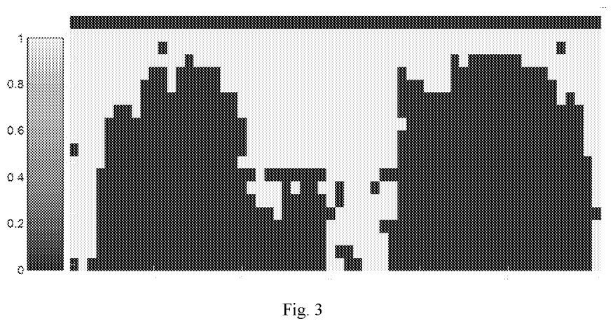

Step (S1-2) The dimensionality reduction is performed in the spatial-wise dimension to obtain a derivative with feature distribution characteristics, as shown in FIG. 3.

Although the descriptors have realized key information extraction from original environmental measurement data, relieving the problems of large data volume and difficult storage associated with the original measurement data, issues such as low efficiency still persist during position searching. The present disclosure utilizes feature extraction in different dimensions for the complex descriptors from two aspects, thus obtaining a rapid retrieval key with rotation invariance and the derivative with feature distribution characteristics. Through the key reduction technique, a k-dimensional tree (KD-Tree) is constructed using the rapid retrieval key during the retrieval process, thereby enabling an efficient and rapid retrieval. Specifically, modulus values of the complex descriptors are first calculated, and average value for each row is calculated to derive the row-wise mean. Then, the modulus values are mapped onto a logical matrix identical in size to the original descriptor via logical mapping, which is used to reflect feature distribution.

The step (S1-1) is performed as follows.

For an original complex descriptor Cᵢⱼ=Rᵢⱼ+Iᵢⱼ(i≤Nr, j≤Ns), which is a two-dimensional (2D) complex matrix having Nr rows and Ns columns and corresponds to a plurality of curvilinear trapezoids formed by radial and circumferential segmentation of a lidar, a real part Rᵢⱼ and an imaginary part Iᵢⱼ of the original complex descriptor are configured to store two main features of the plurality of curvilinear trapezoids respectively. A modulus value for each complex element of the original complex descriptor is calculated, expressed as:

$${M}_{ij} = mod ( {C}_{ij} ) = \sqrt{{R}_{ij}^{2} + {I}_{ij}^{2}} ( i \leq N r , j \leq Ns ) . \qquad ( 1 )$$

In Equation (1), Miⱼ is a real matrix identical in structure and size to the original complex descriptor, and is defined as a modulus matrix storing a modulus value of the original complex descriptor, which can reflect the intensity of its primary features. Then, the original complex descriptor is degenerated into an Nr-dimensional column vector K=[k₁, k₂, . . . , k_{Nr}] to further compress original feature information, where kᵢ is expressed as:

$${k}_{i} = {\sum }_{j = 1}^{{N}_{s}} {M}_{ij} . \qquad ( 2 )$$

An average value of each row vector of the modulus matrix is calculated. Original row information is reflected through the average value, so that the original complex descriptor is compressed into a one-dimensional vector. Since the rows of the original complex descriptor store the full-circle information of the measurement points, averaging the information of each row endows the resulting vector with heading rotation invariance.

The step (S1-2) is performed as follows.

The original complex descriptor is converted into a column vector, and a logical derivative is calculated through Equation (3) to reflect feature distribution of the original descriptor:

$${B}_{ij} = \{ \begin{matrix}1 & \vert {C}_{ij} \vert \neq 0 \\ 0 & \vert {C}_{ij} \vert = 0\end{matrix} ( i \leq {N}_{s} , j \leq {N}_{r} ) . \qquad ( 3 )$$

The logical derivative is a logical matrix identical in structure and size to the original complex descriptor, and is configured for recording the feature distribution of the original descriptor by calculating a feature modulus of each element of the original complex descriptor.

The rapid retrieval and filtration is performed by means of the derivative of the constructed complex descriptor using the database, and the filtered complex descriptor is configured as a potential candidate.

The derivatives of the original descriptor are constructed from different aspects through the step (S1), and these derivatives are then used to efficiently retrieve and filter the most probable candidate from a to-be-determined dataset.

Step (S2-1) Rapid retrieval is performed by means of the derivative having rotation invariance, so that a plurality of potential candidates are acquired, that is, complex descriptors that meet a preset threshold are obtained through rapid retrieval.

To-be-searched descriptors are all constructed as rotation-invariant column vectors K, and a KD-Tree is constructed as a search object. For each to-be-searched candidate, N closest candidates are selected as initial candidates based on the KD-Tree:

$${Φ}_{c} = KD - Tree ( {K}_{c u r r e n t} , N ) . \qquad ( 4 )$$

In Equation (4), Φ_{c} is defined as a set of N candidates closest to the current column vector K_{current}.

Step (S2-2) Rapid filtration is performed by using the logical derivative to remove incorrect candidates.

Although the initial candidates obtained in the step (S2-1) exhibit a degree of similarity to the current measurement values, a significant amount of time would undoubtedly be wasted if the corresponding descriptors were directly used for precise matching. The present disclosure utilizes derivatives with identical feature distributions to rapidly filter out results with low feature similarity among these initial candidates, thereby retaining the optimal candidate. This leads to reduced pressure of subsequent precise matching and improved overall efficiency of place recognition. In the process of location recognition, in order to handle potential heading differences that may arise from visits in various directions, such as forward, reverse, or 90-degree orientations, it is necessary to estimate a heading difference k between two visits through the following equation:

$$k = \{ k \vert {max}_{k = 1}^{N} ( {\sum }_{j = 1}^{{N}_{s}} {B}_{k}^{j} ⊕ {B}_{c u r r e n t}^{j} ) \} ( {B}_{k} ∈ {Φ}_{c} ) . \qquad ( 5 )$$

In Equation (5),

$${B}_{k}^{j}$$

represents a k-th point could descriptor in a candidate set, and

$${B}_{current}^{j}$$

represent a current point cloud descriptor in the candidate set.

Exclusive OR (XOR) operation is performed on the logical descriptors corresponding to the current descriptor and the initial candidates, respectively, to calculate the point cloud candidate with the closest feature distribution to the current measurement. However, in practice, heading difference may exist during re-visiting, leading to errors in similarity calculation. Column shifting is thus performed on the candidates. Since the original complex descriptors are segmented radially and circumferentially, with different columns representing different headings, the present disclosure achieves the effect of rotating the heading angle by shifting columns, and thus obtains the optimal matching result by rotating the heading angle:

$$( k , {shift}^{*} ) = \{ ( k , shift ) \vert {max}_{k = 1}^{N} ( {\sum }_{j = 1}^{{N}_{s}} {B}_{k}^{j} ⊕ {B}_{C}^{j + shift} ) \} ( {B}_{k} ∈ {Φ}_{c} ) . \qquad ( 6 )$$

In Equation (6), shift denotes a heading difference between two scans.

Step (S3) Precise matching is performed by virtue of the characteristics of multiple angles of complex vectors.

An angle between two vectors is used to evaluate the distance between the two vectors. However, when dealing with matrices employing complex descriptors, the vector distance in the real number domain cannot be adopted to calculate the distance. A precise matching method for complex descriptors is proposed herein by analyzing the characteristics of different associated angles. For vector angles in the real number space, the angle between two vectors is calculated by dividing the inner product of the vectors by the product of their corresponding moduli, and the distance or similarity between the two vectors is evaluated based on the calculated angle. For real-number vectors a=(a₁, a₂, . . . , aₙ) and b=(b₁, b₂, . . . , bₙ) (where aᵢ, bᵢ∈R, R refers to the set of real numbers), an angle between vectors a and b can be expressed as:

$$cos {Θ}_{R} ( a , b ) = \frac{{( a , b )}_{R}}{\vert a \vert * \vert b \vert} \qquad ( 7 )$$

In Equation (7), (a,b)_{R} represents an inner product of vectors a and b in the real number space, which is calculated in detail as follows:

$${( a , b )}_{R} = {\sum }_{i = 1}^{n} {a}_{i} * {b}_{i} \qquad ( 8 )$$

$$\vert a \vert = \sqrt{{\sum }_{i = 1}^{n} {a}_{i} * {a}_{i}} \qquad ( 9 )$$

$$\vert b \vert = \sqrt{{\sum }_{i = 1}^{n} {b}_{i} * {b}_{i}} \qquad ( 10 )$$

Let complex vectors be defined as follows:

$$c = ( {c}_{1} , {c}_{2} , … , {c}_{n} ) , d = ( {d}_{1} , {d}_{2} , … , {d}_{n} ) . \qquad ( 11 )$$

The same operations as those in the real number domain can be performed to obtain:

$$cos {Θ}_{\vert} ( a , b ) = \frac{{( a , b )}_{▯}}{\vert a \vert * \vert b \vert} . \qquad ( 12 )$$

In the Equation (12), ⊙ₙ(a,b) represents a complex angle between the complex vectors a and b in the complex number space, and the inner product of the complex vectors a and b in the complex space is calculated as:

$${( a , b )}_{⊓} = {\sum }_{i = 1}^{n} {\overline{a}}_{i} * {b}_{i} . \qquad ( 13 )$$

In practice, the calculated cosine value of this complex angle is a complex number, which can be expanded using Euler's formula as follows:

$$cos {Θ}_{∠} ( a , b ) = ρ {e}^{i * φ} \qquad ( 14 )$$

In Equation (14), ρ is a modulus of the complex cosine value corresponding to the complex angle, and φ is a corresponding argument. In a case where ρ≤1:

$$ρ = cos {Θ}_{H} ( a , b ) = \vert cos {Θ}_{▯} ( a , b ) \vert . \qquad ( 15 )$$

In Equation (15), ⊙_{H}(a,b) is a Hermitian angle between the complex vectors a and b, and φ=φ(a,b) is a pseudo-angle between the complex vectors a and b. For an existing complex descriptor C_{C} and a potential point cloud candidate descriptor C_{H}, their real part, imaginary part, and total distance are calculated through the following equations, respectively, so as to comprehensively judge the similarity of the complex descriptors.

### Total Score:

$$d ( {C}_{H} , {C}_{C} ) = \frac{1}{{N}_{s}} * {\sum }_{j = 1}^{{N}_{s}} [ {ρ}_{j} + {I}_{j} ] \qquad ( 16 )$$

$${I}_{j} = \frac{tan ( {pesudo}_{j} ) * R ( {complex}_{j} )}{{\sum }_{k = 1}^{{N}_{r}} [ max [ {C}_{H}^{j} , {C}_{C}^{j} ] ]} * norm ( {C}_{H}^{j} ) * nor m ( {C}_{C}^{j} ) .$$

### Real Part Score:

$$\frac{1}{{N}_{s}} * {\sum }_{j = 1}^{{N}_{s}} {ρ}_{j} . \qquad ( 17 )$$

### Imaginary Part Score:

$$\frac{1}{{N}_{s}} * {\sum }_{j = 1}^{{N}_{s}} [ {I}_{j} ] . \qquad ( 18 )$$

In the present disclosure, derivatives of complex descriptors are constructed to obtain different features of the original descriptors. Then, potential candidates are rapidly retrieved and filtered by means of the constructed derivatives, respectively. Finally, precise matching of the same position is completed by utilizing the characteristics of multiple angles of complex vectors. Derivatives corresponding to different features are obtained by considering the characteristics of the original complex descriptors, thereby improving the utilization efficiency of the original complex descriptors. Considering the inefficiency of traditional brute-force search, potential candidates are rapidly retrieved and filtered hierarchically from the candidate data with the help of the derivatives of the descriptors. By virtue of the different characteristics of multiple angles of complex vectors, the information utilization degree of the descriptors is improved, and the accuracy of place recognition is enhanced.

What is claimed is:

1. A point cloud descriptor matching method based on complex vector angle characteristics, comprising:
(S1) performing dimensionality reduction on an original complex descriptor to obtain a complex descriptor derivative;
(S2) performing, by using the complex descriptor derivative, rapid retrieval and rapid filtering in a database to obtain filtered complex descriptors; and
(S3) performing, by utilizing multiple angle characteristics of complex vectors, similarity comparison on the filtered complex descriptors to obtain a complex descriptor with a preset accuracy among the filtered complex descriptors.

2. The point cloud descriptor matching method of claim 1, wherein the dimensionality reduction is performed in a column-wise dimension and a spatial-wise dimension, respectively.

3. The point cloud descriptor matching method of claim 2, wherein the dimensionality reduction is performed in the column-wise dimension to obtain a derivative having rotation invariance.

4. The point cloud descriptor matching method of claim 3, wherein the original complex descriptor is expressed as Cᵢⱼ=Rᵢⱼ+Iᵢⱼ(i≤Nr,j≤Ns), which is a two-dimensional (2D) complex matrix having Nr rows and Ns columns and corresponds to a plurality of curvilinear trapezoids formed by radial and circumferential segmentation of a lidar, and a real part Rᵢⱼ and an imaginary part Iᵢⱼ of the original complex descriptor are configured to store two main features of the plurality of curvilinear trapezoids respectively; and
step (S1) comprises:
calculating a modulus value for each complex element of the original complex descriptor, expressed as:
$${M}_{ij} = mod ( {C}_{ij} ) = \sqrt{{R}_{ij}^{2} + {I}_{ij}^{2}} ( i \leq N r , j \leq Ns ) , \qquad ( 1 )$$
wherein in equation (1), Mᵢⱼ is a real matrix identical in structure and size to the original complex descriptor, and is defined as a modulus matrix storing a modulus value of the original complex descriptor;
degenerating the original complex descriptor into an Nr-dimensional column vector K=[k₁, k₂, . . . , k_{Nr}] to further compress original feature information, wherein kᵢ is expressed as:
$${k}_{i} = {\sum }_{j = 1}^{{N}_{s}} {M}_{ij} ; \qquad ( 2 )$$
and
calculating an average value of each row vector of the modulus matrix, and reflecting original row information through the average value, so that the original complex descriptor is compressed into a one-dimensional vector.

5. The point cloud descriptor matching method of claim 2, wherein the dimensionality reduction is performed in the spatial-wise dimension to obtain a derivative having feature distribution characteristics.

6. The point cloud descriptor matching method of claim 5, the derivative having the feature distribution characteristics is obtained through steps of:
calculating a logical derivative through equation (3) to reflect feature distribution of the original complex descriptor:
$${B}_{ij} = \{ \begin{matrix}1 & \vert {C}_{ij} \vert \neq 0 \\ 0 & \vert {C}_{ij} \vert = 0\end{matrix} ( i \leq {N}_{s} , j \leq {N}_{r} ) , \qquad ( 3 )$$
wherein the logical derivative is a logical matrix identical in structure and size to the original complex descriptor, and is configured for recording the feature distribution of the original descriptor by calculating a feature modulus of each element of the original complex descriptor.

7. The point cloud descriptor matching method of claim 1, wherein the rapid retrieval is performed by using a derivative having rotation invariance to obtain complex descriptors meeting a preset threshold, and the rapid filtering is performed by using a derivative having identical feature distribution to remove results having low feature similarity from the complex descriptors meeting the preset threshold, thereby retaining an optimal complex descriptor.

8. A point cloud descriptor matching system based on complex vector angle characteristics, comprising:
a derivative construction module;
a retrieval and filtering module; and
a matching module;
wherein the derivative construction module is configured to perform dimensionality reduction on an original complex descriptor to obtain a complex descriptor derivative;
the retrieval and filtering module is configured to perform, by using the complex descriptor derivative, rapid retrieval and rapid filtering in a database to obtain filtered complex descriptors; and
the matching module is configured to perform, by utilizing multiple angle characteristics of complex vectors, similarity comparison on the filtered complex descriptors to obtain a complex descriptor with a preset accuracy among the filtered complex descriptors.

9. The point cloud descriptor matching system of claim 8, wherein the dimensionality reduction is performed in a column-wise dimension and a spatial-wise dimension, respectively; and the dimensionality reduction is performed in the column-wise dimension to obtain a derivative having rotation invariance.

10. The point cloud descriptor matching system of claim 9, wherein the original complex descriptor is expressed as Cᵢⱼ=Rᵢⱼ+Iᵢⱼ(i≤Nr, j≤Ns), which is a 2D complex matrix having Nr rows and Ns columns and corresponds to a plurality of curvilinear trapezoids formed by radial and circumferential segmentation of a lidar, and a real part Rᵢⱼ and an imaginary part Iᵢⱼ of the original complex descriptor are configured to store two main features of the plurality of curvilinear trapezoids respectively; and
the derivative construction module is configured to perform steps of:
calculating a modulus value for each complex element of the original complex descriptor, expressed as:
$${M}_{ij} = mod ( {C}_{ij} ) = \sqrt{{R}_{ij}^{2} + {I}_{ij}^{2}} ( i \leq N r , j \leq Ns ) , \qquad ( 1 )$$
wherein in equation (1), Mᵢⱼ is a real matrix identical in structure and size to the original complex descriptor, and is defined as a modulus matrix storing a modulus value of the original complex descriptor;
degenerating the original complex descriptor into an Nr-dimensional column vector K=[k₁, k₂, . . . , k_{Nr}] to further compress original feature information, wherein kᵢ is expressed as:
$${k}_{i} = {\sum }_{j = 1}^{{N}_{s}} {M}_{ij} ; \qquad ( 2 )$$
and
calculating an average value of each row vector of the modulus matrix, and reflecting original row information through the average value, so that the original complex descriptor is compressed into a one-dimensional vector.
